(19) United States
(12) Patent Application Publication
(10) Pub. No.: US 2010/0220569 A1
(43) Pub. Date: Sep. 2, 2010

(54) FINAL AREA RETRIEVING APPARATUS, INFORMATION REPRODUCING APPARATUS, FINAL AREA RETRIEVING METHOD, AND FINAL AREA RETRIEVING PROGRAM

(75) Inventors: Takaaki Ujiie, Kawagoe-shi (JP); Yoshimichi Nishio, Kawagoe-shi (JP); Yoshihiro Hashizuka, Kawagoe-shi (JP); Hideaki Tsurumi, Kawagoe-shi (JP); Hiroyuki Enomoto, Kawagoe-shi (JP); Hideyasu Iwano, Kawagoe-shi (JP); Chikashi Kuwahara, Kawagoe-shi (JP); Manabu Shimodaira, Kawagoe-shi (JP); Hiroshi Someya, Kawagoe-shi (JP); Hidetaka Urabe, Kawagoe-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 12/159,483

(22) PCT Filed: Dec. 7, 2006
(86) PCT No.: PCT/JP2006/324472

§ 371 Date: Jun. 27, 2008

(30) Foreign Application Priority Data
Dec. 28, 2005 (JP) 2005-379296

(51) Int. Cl. G11B 27/36

(52) U.S. Cl. 369/53.24; G9B/27.052

(57) ABSTRACT

A final area retrieving apparatus, an information reproducing apparatus, a final area retrieving method, and a final area retrieving program are provided, which are capable of decreasing a period of time necessary for acquiring information necessary for reproduction of optical disc.

When a final area of optical disc D is retrieved, a system control unit 6 stores a start address of the area, and the like in a flash memory 5. When the optical disc D is inserted again, and a final area is newly retrieved, it is determined whether a final area retrieved at the last time exists on the optical disc D, based on a starting address of final area stored in the flash memory 5. In a case where it is determined that a final area retrieved at the last time exists on the optical disc D, the acquisition of start address of next area, and the like is started from a final area retrieved at the last time, and a final area is retrieved.

### TECHNICAL FIELD

The present invention relates to a technical field of a final area retrieving apparatus, an information reproducing apparatus, a final area retrieving method, and a final area retrieving program which retrieves an area in which information has been finally recorded, from a recorded medium on which information has been recorded, by a recording method by which a plurality of information pieces can be additionally recorded on the recorded medium with one information piece recorded in each divided area, and by which next-area position information indicative of a position of next-area in which information is next-time recorded is recorded in the area.

### BACKGROUND ART

Recently, in a technical field of recorded medium such as a CD (Compact Disc) and DVD (Digital Versatile Disc), an optical disc on which information can be optically recorded, for example, CD-R, CD-RW, DVD±R, DVD-RW, and so on, has been generally spread

As one of recording methods for such optical disc, a recording method which is called incremental-writing is standardized in various fields. According to incremental-writing, after a data has been once recorded on an optical disc, if there is a space on the optical disc, new information can be additionally recorded.

For Example, in a case of a multi-border method which a DVD forum standardized, a border (an area) indicative of one information piece is composed of three elements, i.e., a border-in area, a user-data area, and a border-out area. Information is recorded in each border on an optical disc (in this case, DVD-R, DVD-RW).

In order to reproduce all recorded information, by an information reproduction apparatus, from an optical disc which information has been thus recorded, it is necessary to acquire at least file system information (including address information and the like of a file and a directory recorded in a user data area).

As a conventional method of acquiring such information, for example, as shown in Patent Document No. 1, control information recorded in an extra border area of lead-in area is acquired first, and by using a border-in start address of next border included in the control information, control information of second border is acquired. By using a border-in start address of further next border, control information of third border is acquired. Thus, the positions of the respective borders are successively specified. By retrieving a final border, it is possible to acquire file system information recorded in a border-in area of the final border.

In a case of certain reproduction method and the like, it is necessary to acquire a border-in start address, a border-out start address and the like, of each border. However, such information can be acquired from control information and the like recorded in a border-in area of each border during a process of retrieving a final border mentioned above.

In a case of CD-R, CD-RW, DVD+R, DVD-RW, and the like on which information has been recorded by a multi-session method, information necessary for reproduction is acquired, basically by the same method as the above.

### Patent Document No. 1: Japanese Patent Laid-open No. 2005-71485

### DISCLOSURE OF THE INVENTION

### Problem that the Invention is to Solve

In a case of the above-mentioned conventional method, however, each time an optical disc is inserted into an information reproduction apparatus, all areas of the optical disc need to be accessed. The more the number of areas formed in an optical disc is, the longer a period of time necessary for acquiring information necessary for reproduction of an optical disc is. Thus, a waiting time until the reproduction of optical disc becomes possible is long, resulting in a problem.

The present invention has been made in consideration of the above-mentioned problem, and it is an object of the present invention to provide a final area retrieving apparatus, an information reproducing apparatus, a final area retrieving method, and a final area retrieving program capable of decreasing a period of time necessary for acquiring information necessary for reproduction of optical disc.

### Means for Solving the Problem

In order to solve the above problem, an aspect of the invention relates to a final area retrieving apparatus, comprising:

acquiring means for acquiring information necessary for reproduction of recorded information, from a recorded medium on which information has been recorded, by a recording method by which a plurality of information pieces can be additionally recorded on the recorded medium with one information piece recorded in each divided area, and by which next-area position information indicative of a position of next-area in which information is next-time recorded is recorded in the area, and

wherein the final area retrieving apparatus retrieves a final area in which information has been finally recorded on the recorded medium,

the final area retrieving apparatus, comprising:

retrieving means for starting retrieval of the next area position information by the acquiring means, from an area in which information has been firstly recorded on the recorded medium, and successively specifying the position of area in which information has been next-time recorded, to retrieve a final area,

storing means for storing at least final area position information indicative of the position of the retrieved final area, and

final area presence determining means for, at the time of newly retrieving the final area by the retrieving means, determining whether the retrieved final area exists on the recorded medium being newly retrieved, based on the stored final area position information,

wherein in a case where it is determined by the final area determining means that the retrieved final area exists, the retrieving means starts acquiring of the next area position information by the acquiring means, from the final area, to newly retrieve the final area.

In order to solve the above problem, another aspect of the invention relates to an information reproducing apparatus, comprises:

a final area retrieving apparatus according to claim 1, and

reproduction control means for controlling reproduction of recorded information from the recorded medium, based on the acquired information.

In order to solve the above problem, still another aspect of the invention relates to a final area retrieving method carried out in a final area retrieving apparatus,

wherein the final area retrieving apparatus comprises:

acquiring means for acquiring information necessary for reproduction of recorded information, from a recorded medium on which information has been recorded, by a recording method by which a plurality of information pieces can be additionally recorded on the recorded medium with one information piece recorded in each divided area, and by which next-area position information indicative of a position of next-area in which information is next-time recorded is recorded in the area, and

reproduction control means for controlling reproduction of recorded information from the recorded medium, based on the acquired information

wherein the final area retrieving apparatus retrieves a final area in which information has been finally recorded on the recorded medium,

the final area retrieving method, comprising:

a first retrieving process of starting retrieval of the next area position information by the acquiring means, from an area in which information has been firstly recorded on the recorded medium, and successively specifying the position of area in which information has been next-time recorded, to retrieve a final area,

a storing process of storing at least final area position information indicative of the position of the retrieved final area,

a final area presence determining process of, at the time of newly retrieving the final area, determining whether the retrieved final area exists on the recorded medium being newly retrieved, based on the stored final area position information, and

a second retrieving process of, in a case where it is determined in the final area presence determining process that the retrieved final area exists, starting acquiring of the next area position information by the acquiring means, from the final area, to newly retrieve the final area.

In order to solve the above problem, yet another aspect of the invention relates to a final area retrieving program, causing a computer included in a final area retrieving apparatus, comprising:

acquiring means for acquiring information necessary for reproduction of recorded information, from a recorded medium on which information has been recorded, by a recording method by which a plurality of information pieces can be additionally recorded on the recorded medium with one information piece recorded in each divided area, and by which next-area position information indicative of a position of next-area in which information is next-time recorded is recorded in the area, and

wherein the final area retrieving apparatus retrieves a final area in which information has been finally recorded on the recorded medium,

to function as:

retrieving means for starting retrieval of the next area position information by the acquiring means, from an area in which information has been firstly recorded on the recorded medium, and successively specifying the position of area in which information has been next-time recorded, to retrieve a final area,

storing means for storing at least final area position information indicative of the position of the retrieved final area, and

final area presence determining means for, at the time of newly retrieving the final area by the retrieving means, determining whether the retrieved final area exists on the recorded medium being newly retrieved, based on the stored final area position information,

wherein in a case where it is determined by the final area presence determining means that the retrieved final area exists, the retrieving means starts acquiring of the next area position information by the acquiring means, from the final area, to newly retrieve the final area.

### BRIEF DESCRIPTION OF THE DRAWINGS

FIG. 1 is a block diagram showing an example of schematic structure of optical disc reproduction apparatus according to an embodiment of the present invention.

FIG. 2 is a view showing an example of schematic structure of information stored in a flash memory 5 according to an embodiment of the present invention.

FIG. 3 is a flowchart showing an example of final area retrieving process carried out by system control unit 6 of optical disc reproduction apparatus S according to an embodiment of the present invention.

FIG. 4 is a flowchart showing an example of final area retrieving process carried out by system control unit 6 of optical disc reproduction apparatus S according to an embodiment of the present invention.

FIGS. 5A and 5B are views showing an example of manner until a final area is retrieved, and FIG. 5A shows a conventional case, and FIG. 5B shows a case according to an embodiment of the present invention.

### DESCRIPTION OF REFERENCE NUMERALS AND SIGNS

1: spindle motor
2: pickup
3: servo circuit
4: information reproduction unit
5: flash memory
6: system control unit
S: optical disc reproduction apparatus
D: optical disc

### BEST MODE FOR CARRYING OUT THE INVENTION

Referring now to the drawings, a preferred embodiment of the present invention will be described in detail.

An embodiment mentioned below is one in which the present invention is applied to an optical disc reproduction apparatus which is compliant with DVD-R, and DVD-RW recorded according to a multi-border method which is an example of incremental writing method, and CD-R, and CD-RW recorded according to a multi-session method.

### [1. Overview of Structure and Function of Optical Disc Reproduction Apparatus]

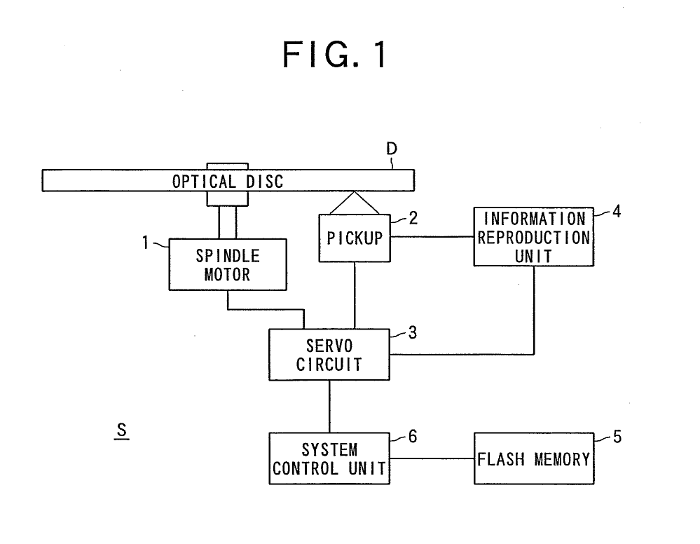

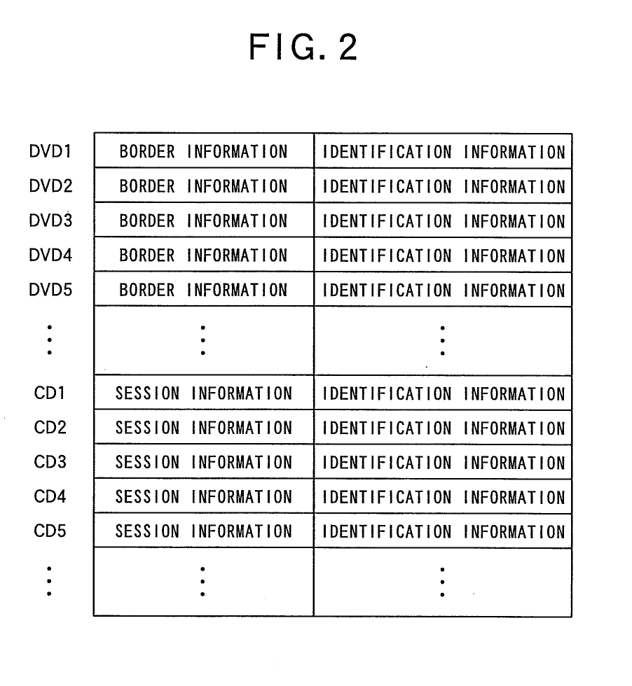

First, a structure and a function of optical disc reproduction apparatus according to the present embodiment will be described with reference to FIG. 1 and FIG. 2.

FIG. 1 is a block diagram showing an example of schematic structure of optical disc reproduction apparatus according to the present embodiment.

As shown in FIG. 1, an optical disc reproduction apparatus S is arranged to comprise a spindle motor 1, a pickup 2, a servo circuit 3, an information reproduction unit 4, a flash memory 5, and a system control unit 6. An optical disc D is arranged to be loaded in a tray of loading mechanism (not shown) provided in the optical disc reproduction apparatus S, or arranged to be transferred by a rotating roller (not shown), so as to be inserted in the apparatus S.

The spindle motor 1 is arranged to rotate the optical disc D placed at a predetermined clamp position on a turntable (not shown).

The pickup 2 is arranged to irradiate a light beam on the optical disc D by a semi-conductor laser element unit (not shown), detect its reflection light by an optical sensor, and output its detection signal to the servo circuit 3 and the information reproduction unit 4. The semi-conductor laser element unit is composed of a laser element for DVD which irradiates a light beam of 650-nm wave length for DVD, and a laser element for CD which irradiates a light beam of 780-nm wave length for CD. These elements are arranged to irradiate a light beam by a drive electrical current from a drive circuit (not shown) controlled by the system control unit 6. The pickup 2 is provided with an actuator which is composed of a focusing portion for moving an objective lens (not shown) in a direction of optical axis, and a tracking portion for moving the objective lens in a radial direction of disc perpendicular to the optical axis.

The servo circuit 3 is arranged, under the control of the system control unit 6, to produce a tracking error signal and a focus error signal based on a detection signal outputted from the pickup 2, and to servo-control the spindle motor 1 and the pickup 2 based on these signals, namely, to control the velocity of the optical disc D, a tracking position of the pickup 2, a focus position of light beam and the like, by forming a closed circuit loop. The servo circuit 3 converts the produced tracking error signal into a binary form, and supplies the binary signal to the system control unit 6.

The information reproduction unit 4, under the control of the system control unit 6, converts the detection signal outputted from the pickup 2, to an RF signal by an RF (Radio Frequency) amplifier, and after a binary conversion, restore recorded information (data) of the optical disc D by carrying out a decoding process, an error correction process, and the like. The information reproduction unit 4 carries out a decoding process for restored recorded-information (video data, audio data, computer program, data, and the like) so as to reproduce the recorded information. A video data of the reproduced recorded-information is outputted through a picture process circuit (not shown) to a display, an audio data thereof is outputted through an audio process circuit (not shown) to a speaker, and a computer program, control information mentioned below, TOC (Table Of Contents) information, and the like are outputted to the system control unit 6.

The flash memory 5 is a non-volatile memory for storing and holding a variety of settings, data, and the like.

FIG. 2 is a view showing an example of schematic structure of information stored in the flash memory 5 according to an embodiment of the present invention.

As shown in FIG. 2, in the flash memory 5, a plurality of sets are stored, each set including border information of DVD-R or DVD-RW on which information has been recorded according to a multi-border method (hereinafter, referred to as a multi-border DVD), and identification information of its optical disc, in such a manner that the border information and the identification information correspond to each other. Further, in the flash memory 5, a plurality of sets are stored, each set including session information of CD-R or CD-RW on which information has been recorded according to a multi-session method (hereinafter, referred to as a multi-session CD), and identification information of its optical disc, in such a manner that the session information and the identification information correspond to each other.

Each of the border information and the session information is referred to by the system control unit 6 to reproduce recorded information from the optical disc D. In order to link the border information and the session information of the optical disc D with the optical disc D, the identification information is information for identifying the optical disc D. Such information is arranged to be acquired by the system control unit 6, when the optical disc D is inserted in the optical disc reproduction apparatus S.

In a case where an optical disc D is a multi-border DVD, in the optical disc D, as mentioned above, a plurality of borders (an example of area) are formed, each border being composed of a border-in area, a user data area, and a border-out area. In a border-in area of each border, a border-out start address of the border, a border-in start address of next border (an example of position information of next area) and the like are recorded as control information. In a border-in area of final border, newest file system information of the optical disc D is recorded.

As information for reproducing recorded information from the optical disc D of such structure, for example, there are a border-in start address, and a border-out start address of each border, a size of user data, a total number of borders, a file system, and the like. Such information is arranged to be stored in the flash memory 5 based on information recorded in each border-in area.

If file system information can be acquired, basically, recorded information of the optical disc D can be reproduced, although it depends on a reproduction method and the like. As mentioned below, the optical disc reproduction apparatus S is arranged to always acquire information recorded in a lead-in area of the optical disc D, and information recorded in a border-in area of final border at the time of last insertion of optical disc, each time the optical disc D is newly inserted. Therefore, it is sufficient that at least a border-in start address of final border is stored in the flash memory 5.

As the identification information of the optical disc D, for example, information indicative of file structure of first border recorded in a first user data area (which is included in newest file system information) and the like is available, although the invention is not limited to it.

In a case where the optical disc D is a multi-session CD, a plurality of sessions (an example of area) are formed in the optical disc D, each session being composed of three elements, i.e., a lead-in area, a program area, and a lead-out area. In a lead-in area of each session, as TOC information, there are recorded a track number of track recorded in its own session, a start time of the track, flag information indicative of whether or not it is a ROM track, a lead-out start time of the session, and the like.

As information for reproducing recorded information from the optical disc D of such structure, for example, there are a track number of each session, a start time of the track, flag information indicative of whether or not it is a ROM track, a lead-out start time of each session, and the like. Such information is arranged to be stored in the flash memory 5 based on TOC information.

As the identification information of the optical disc D, for example, a track start time included in TOC information of lead-in area of first session (an example of area in which information has been first recorded), and the like is available, although the invention is not limited to it.

Contents of border information and session information stored in the flash memory 5 are not limited to the above-mentioned information, and can change according to a reproduction method and the like. It is sufficient that identification information stored in the flash memory 5 is information capable of identifying the optical disc D. Therefore, it is possible that the identification information is arranged based on a combination of information pieces located at a plurality of locations, for example. In order to reduce the number of access for the optical disc D, however, it is desirable that all information pieces are recorded in a lead-in area. If the identification information is included in border information or session information, an area for identification information need not to be provided in the flash memory 5 separately.

The system control unit 6 is arranged to include a CPU (Central Processing Unit) having a function of calculating process, a ROM (Read Only Memory) in which a variety of programs (for example, including a program for final area retrieving process and the like, and this program can be down-loaded from a server via a network such as an internet, or can be provided from a recorded medium such as an optical disc D on which the program has been stored), a data, and the like are stored, a working RAM (Random Access Memory), and the like. As the CPU carries out the program, the system control unit 6 is arranged to function as acquiring means, storing means, retrieving means, means for determining presence of final area, identification information determining means, and the like.

Specifically, the system control unit 6 as acquiring means is arranged to acquire information necessary for reproduction (for example, the above-mentioned control information, file system information, TOC information, and the like) and identification information from the optical disc D according to a kind of the optical disc D, and store such information in a RAM. The system control unit 6 as storing means stores a portion or all of information necessary for reproduction of the optical disc D stored in the RAM, as border information or session information in the flash memory 5 in such a manner that such information and its identification information correspond to each other.

The system control unit 6 as retrieving means is arranged, in a case where the optical disc D is a multi-border DVD, to start acquisition of control information and the like from a first border (an area in which information has been first recorded), and specify a position of each border successively by a border-in start address of next border included in the control information so as to retrieve a final border. The system control unit 6 is arranged, in a case where the optical disc D is a multi-session CD, to start acquisition of TOC information and the like from a first session, and specify a lead-in start time of next session each based on a lead-out start time of the session included in the TOC information to specify a position of each border successively so as to retrieve a final session (since a lead-out start time of the session included in TOC information has such meaning, it is an example of next area position information).

The system control unit 6 as identification information determining means is arranged, when the optical disc D is inserted and a final area (a final border or a final session) is newly retrieved, to compare identification information acquired from the optical disc D with identification information stored in the flash memory 5 so as to determine whether the identification information acquired from the optical disc D is stored in the flash memory 5.

The system control unit 6 as means for determining presence of final area is arranged to determine whether a final area at the time of last retrieving exists on the newly inserted optical disc D, by verifying presence indication information specified based on position information of final area stored in the flash memory 5 corresponding to identification information of the optical disc D (a border-in start address of final order stored as border information, or a lead-in start time of final session stored as session information).

For example, in a case where the optical disc D is a multi-border DVD, in a control data zone of lead-in area, a user data start address of first border is recorded. A copy of user data start address of first border is arranged to be also recorded at a predetermined position of border-in area of each border.

If a final border obtained at the time of last retrieving exists on the newly inserted optical disc D, information recorded at the position of the copy on the optical disc D which can be specified based on a border-in start address of final border stored in the flash memory 5 is similar with the start address recorded in a control data zone. If a final border obtained at the time of last retrieving does not exist, there should be discrepancy.

Therefore, the copy can be called information indicative of actual presence of final border on the optical disc D, i.e., an example of presence indication information. Accordingly, by acquiring a start address recorded in a control data zone from a newly inserted optical disc D, and information recorded at the position of the copy specified based on a border-in start address of final border stored in the flash memory 5, and comparing them with each other, it is possible to determine whether a final area at the time of last retrieving exists on the optical disc D.

Here, as a determining method, without acquiring both information pieces from a newly inserted optical disc D, for example, it is also possible to store border information including the start address in the flash memory 5, and compare the stored start address with a copy obtained from a newly inserted optical disc D. It is also possible to store border information including a copy in the flash memory 5, and compare the stored copy with a copy obtained from a newly inserted optical disc D.

As presence indication information, in addition to the above copy, for example, it is also possible to use a final address of user data area of final border recorded in a border-in area of final border, and the like. In this case, the final address is stored in the flash memory 5, and the stored final address and a final address obtained from a newly inserted optical disc D are compared with each other.

In a case where an optical disc D is a multi-session CD, for example, the presence indication information can be applied to a combination of track number recorded in a final session and a start time of the track, and the like. In this case, the session information including the number and the start time is stored in the flash memory 5, and the stored number and start time are compared with a number and a start time obtained from a newly inserted optical disc D.

In a case where a final area at the time of last retrieving exists on a newly inserted optical disc D, the system control unit 6 as retrieving means retrieves a new final area from a final area at the time of last retrieving. Thus, the reason why a final area is retrieved from a halfway area is as follows:

If an optical disc D is an optical disc on which information has been recorded according to an incremental writing method, the disc is, in light of its standard, in a recorded condition in which the same information as the previous time is recorded, new information is additionally recorded on the outer side of final area at the time of last retrieving, or all information has been deleted and another information is recoded. Only a partial area is not deleted. Therefore, in a case where a final area at the time of last retrieving exists on a newly inserted optical disc D, at least information recorded in from a first area to a final area at the time of last retrieving does not change. So, if information necessary for reproduction of recorded information can be obtained from an area formed on the outer side of the final area, then, based on information stored in the flash memory 5, all information recorded on the Optical disc D can be reproduced. In some cases, if information recorded in a final area can be obtained, an optical disc D can be reproduced (for example, file system information in a multi-border DVD, and the like). In this case, if a final area can be retrieved, information in a halfway area is basically unnecessary.

In the present embodiment, therefore, by reducing the number of access for optical disc D, a period of time necessary for acquiring information necessary for reproduction of optical disc (mainly, a period of time necessary for seeking operation for a desired track by a pickup 2 and the like) is reduced.

The system control unit 6 as reproduction control means is arranged to control the reproduction of recorded information from an optical disc D based on information necessary for reproduction recorded in a RAM. The system control unit 6, at the time of control of reproduction of recorded information, sets an optimum reproduction (adjustment necessary for reproduction) according to a kind of optical disc D or information necessary for reproduction. Here, the setting of reproduction is the setting of various constants, parameters, and the like in the spindle motor 1, the pickup 2, the servo circuit 3, and the information reproduction unit 4, for example, the setting concerning a focusing adjustment, a tracking adjustment, an equalizing coefficient of RF amplifier, an adjustment coefficient of tracking error signal based on the difference of track pitch, a servo gain, a PLL setting, an error correction method, a CD-ROM decoding method, and the like.

### [2. Operation of Optical Disc Reproduction Apparatus]

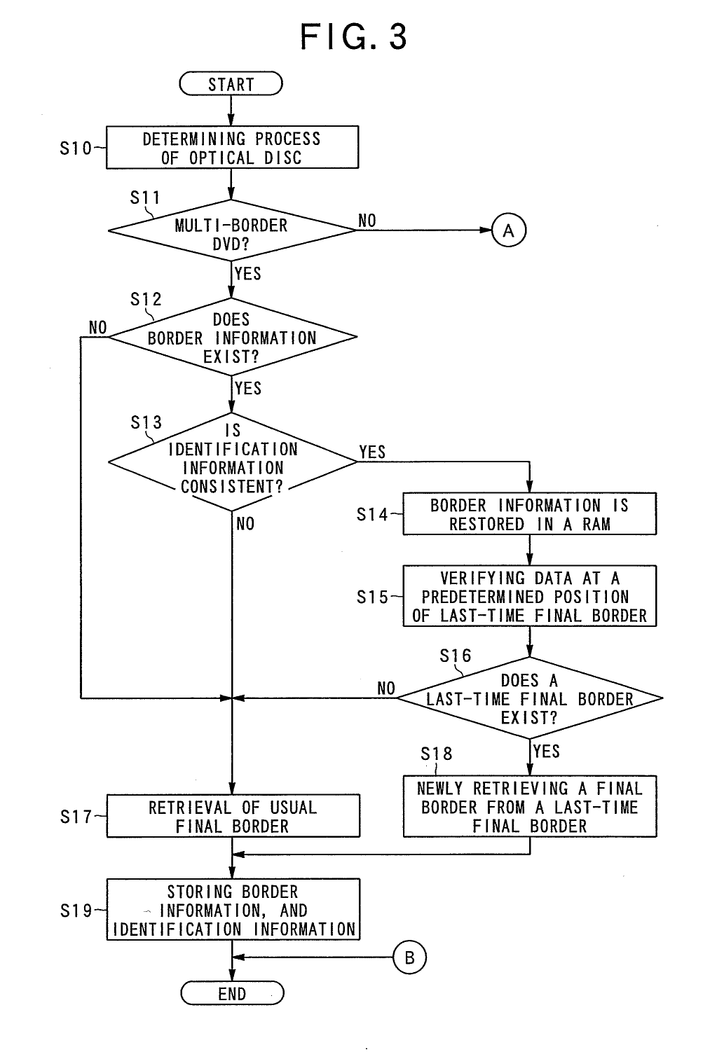

Now, an operation of the optical disc reproduction apparatus S will be described with reference to FIGS. 3 to 5A, and 5B.

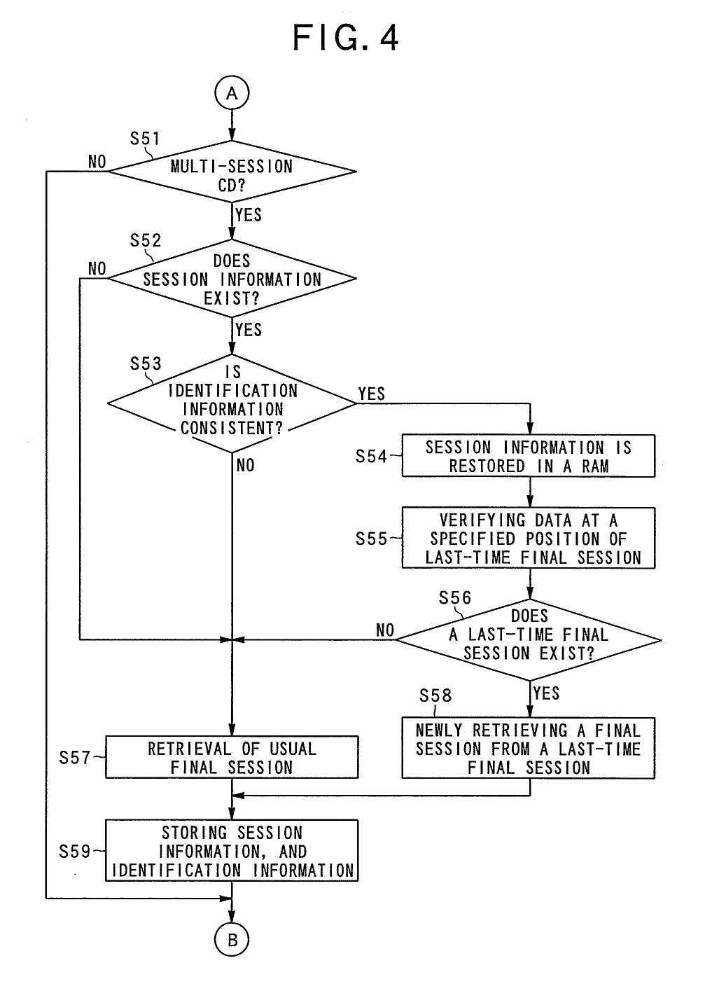

FIGS. 3 and 4 are flowcharts showing an example of final area retrieving process carried out by system control unit 6 of optical disc reproduction apparatus S according to an embodiment of the present invention.

First, when an optical disc D is loaded in a loading mechanism of the optical disc reproduction apparatus S by a user, and is inserted in the apparatus S, as shown in FIG. 3, the system control unit 6 recognizes this condition, and carries out a process of determining an optical disc D (step S10).

For example, the system control unit 6 provides the pickup 2 and the servo circuit 3 with a control command to cause a light beam from a laser element for CD to impinge on the optical disc D and move across tracks in the radial direction of disc. During the moving of light beam across tracks, in a case where the number of binary signal (pulse) of tracking error signal supplied from the servo circuit 3 has become equal to or more than a predetermined value, it is determined that a kind of the optical disc is a CD. In a case where it does not reach the predetermined value, it is determined that a kind of the optical disc D is a DVD.

In a case where an optical disc D is a DVD, the system control unit 6, for example, acquires physical format information and the like recorded in a lead-in area of the optical disc, and based on the acquired information, determines a kind of medium such as DVD-ROM, DVD-R, DVD-RW, DVD-RAM, and a kind such as a single border, a multi-border, a packet writing.

In a case where an optical disc D is a CD, the system control unit 6, for example, acquires TOC information and the like in a lead-in area on the innermost side of the optical disc, and based on the acquired information, determines a kind of medium such as CD-DA, CD-ROM, CD-R, CD-RW, and a kind such as a single session, a multi-session, a packet writing.

Now, the system control unit 6 determines whether an optical disc is a multi-border DVD (step S11), and in a case where the optical disc is not a multi border DVD (step S11, No), the system control unit 6 proceeds to step S51. In a case where the optical disc is a multi border DVD (step S11, Yes), the system control unit 6 proceeds to step S12.

Now, the system control unit 6 determines whether border information is stored in the flash memory 5 (step S12), and in a case where the border information is not stored (step S12, No), a usual process of retrieving of final border is carried out (step S17). In a case where the border information is stored (step S12, Yes), the system control unit 6 proceeds to step S13.

At step S13, the system control unit 6 acquires identification information (for example, information indicative of a file structure of first border recorded in a user data area of first border, and the like) from an optical disc D, compares it with identification information stored in the flash memory 5, and determines whether it is consistent with any stored identification information. In a case where there is no consistent identification information (step S13, No), a usual process of retrieving of final border is carried out (step S17). In a case where there is an consistent identification information (step S13, Yes), border information stored in the flash memory 5 is read out in correspondence with the identification information, and the border information is restored (copied) in a RAM (step S14).

The system control unit 6 carries out a process of verifying presence indication information recorded in a final border at the time of last retrieving (step S15). Specifically, the system control unit 6 acquires a border-in start address of final border at the time of last retrieving, from border information restored in the RAM, and based on the obtained start address, specifies an address at which presence indication information (for example, a copy of a border-in start address of first border, and the like) is recorded, and acquires information corresponding to the presence indication information from the address on the optical disc D. The information is compared with the presence indication information stored in the RAM, or information recorded in a lead-in (for example, a border-in start address of first border, and the like).

Now, the system control unit 6 determines whether there is a last retrieved final border (step S16). Here, as a result of the above comparison, in a case of inconsistency, it is determined that a final border does not exist (step S16, No), and a usual process of retrieving of final border is carried out (step S17). In a case of consistency, it is determined that a final border exists (step S16, Yes), and the system control unit 6 proceeds to step S18.

In a usual process of retrieving of final border at step S17, the system control unit 6 acquires information necessary for reproduction of optical disc D (for example, a border-out start address of border, a border-in start address of next border, and the like) in control information and the like recorded in an extra border area, and stores it as border information in a RAM. The system control unit 6, based on a border-in start address of next border, acquires control information and the like of the next border, and stores it in the RAM. The system control unit 6 repeats such processing, acquires control information, file system information, and the like of final border, and stores it as border information in the RAM.

On the other hand, at step S18, the system control unit 6 acquires information necessary for reproduction of optical disc D in control information and the like recorded in a last-time final border, and stores it as border information in a RAM. Thereafter, from a border next to the last-time final border, the same processing as step S17 is repeated, and control information, file system information, and the like of final border are acquired, and are stored as border information in the RAM.

Lastly, the system control unit 6 stores identification information of optical disc D in the flash memory 5, and stores border information stored in the RAM, in the flash memory 5 in such a manner that it corresponds to the identification information (step S19). Here, it is desirable to store all border information stored in the RAM. However, it is sufficient to store, in the flash memory 5, at least information necessary for reproduction of recorded information of optical disc D by acquiring only information recorded in a border-in area of border after a present final border when an optical disc D being currently inserted is newly inserted.

The system control unit 6 terminates a process of retrieving of final area, and based on the border information stored in the RAM, starts control of reproduction of optical disc D.

At a determining process of step S11, in a case where an optical disc D is not a multi-border DVD (step S11, No), as shown in FIG. 4, the system control unit 6 determines whether the optical disc D is a multi-session CD (step S51). In a case where it is not a multi-session CD (step S51, No), a process of retrieving of final area is terminated. In a case where it is a multi-session CD (step S51, Yes), the system control unit 6 proceeds to step S52.

At step S52, the system control unit 6 determines whether session information is stored in the flash memory 5. In a case where it is not stored (step S52, No), a usual process of retrieving of final session is carried out (step S57). In a case where it is stored (step S52, Yes), the system control unit 6 proceeds to step S53.

At step S53, the system control unit 6 acquires identification information (for example, a start time of track recorded in a first session, and the like) from an optical disc D, and compares it with identification information stored in the flash memory 5, and determines whether it is consistent with any stored identification information. In a case where there is no consistent identification information (step S53, No), a usual process of retrieving of final session is carried out (step S57). In a case where there is consistent identification information (step S53, yes), session information stored in the flash memory 5 is read out in correspondence with the identification information, and the session information is restored in a RAM (step S54).

Now, the system control unit 6 carries out a process of verifying of presence indication information recorded in a final session at the time of last retrieving (step S55). Specifically, the system control unit 6 acquires a lead-in start time of final session at the time of last retrieving, from session information restored in a RAM, and based on the acquired start time, seeks an address at which presence indication information (for example, a start time of track recorded in a final session, and the like) is recorded, and based on the address on the optical disc D, acquires information corresponding to the presence indication information. Then, this information is compared with the presence indication information stored in the RAM or information recorded in a lead-in area.

Now, the system control unit 6 determines whether a last-retrieved final session exists (step S56). Here, at a result of the above comparison, in a case of inconsistency, it is determined that a final session does not exist (step S56, No), a usual process of retrieving of final session is carried out (step S57). In a case of consistency, it is determined that a final session exists (step S56, Yes), and the system control unit 6 proceeds to step S58.

In a usual process of retrieving of final session at step S57, the system control unit 6 acquires information necessary for reproduction of optical disc D (for example, a track number, and a track start time recorded in the session, a lead-out start time of each session, and the like) in TOC information recorded in a lead-in area of first session, and the like, and stores it as session information in a RAM. The system control unit 6, based on a lead-out start time of each session, specifies a lead-in start time of next session (since an approximate period of time for lead-out is determined, it is possible to specify in this manner), acquires TOC information of the next session, and the like, and stores it in the RAM. The system control unit 6 repeats such process, acquires TOC information of final session, and stores it as session information in the RAM.

On the other hand, at step S58, the system control unit 6 acquires information necessary for reproduction of optical disc D in control information and the like recorded in a final session of last time, and stores it as session information in the RAM. Thereafter, from a session next to a final session of last time, the same process as step S57 is repeated, and TOC information and the like of the final session is acquired, and is stored as session information in the RAM.

Lastly, the system control unit 6 stores identification information of optical disc D in the flash memory 5, and stores session information stored in the RAM, in the flash memory 5 in such a manner that it corresponds to the identification information (step S59). Here, it is desirable to store all of session information stored in the RAM. However, it is sufficient to store, in the flash memory 5, at least information necessary for reproduction of recorded information of optical disc D by only acquiring information recorded in a lead-in area of session after the present final session when the optical disc D being currently inserted is newly inserted.

Now, the difference will be described between a process of retrieving of final area carried out by a conventional optical disc reproduction apparatus, and a process of retrieving of final area carried out by a optical disc reproduction apparatus S according to the present embodiment.

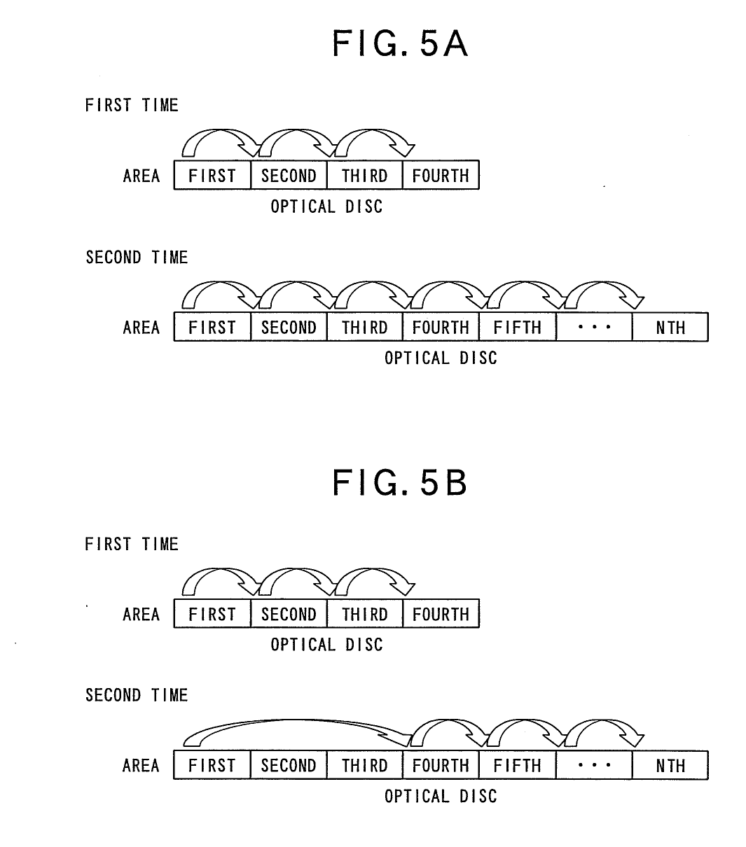

FIGS. 5A and 5B are views showing an example of manner until a final area is retrieved. FIG. 5A shows a conventional case, and FIG. 5B shows a case according to the present embodiment.

In an example of FIGS. 5A and 5B, an explanation will be made, on the assumption that when an optical disc is inserted in an optical disc apparatus firstly (at first time), four areas are formed on the optical disc, and when the optical disc is inserted at second time, information is additionally recorded from the fifth area to an Nth area (N is greater than 4).

First, in a case of conventional optical disc reproduction apparatus, as shown in FIG. 5A, when an optical disc is firstly inserted, a start address of next area and the like (for example, a border-in start address, a lead-in start time, and the like) is acquired from a first area to a fourth area successively. Lastly, file system information and the like is acquired from the fourth area. When the optical disc is inserted at second time, a start address of next area and the like is still acquired from the first area to an Nth area successively, and file system information and the like is acquired from the Nth area.

Thus, in a case of conventional optical disc reproduction apparatus, even if an optical disc is one which has been previously reproduced, and the same information is recorded halfway, a final area is always retrieved based on a first area.

On the other hand, in a case of optical disc reproduction apparatus S according to the present embodiment, as shown in FIG. 5B, when an optical disc is inserted first, identification information recorded in a lead-in area is acquired. In the same manner as in a conventional case, a start address of next area and the like is acquired from a first area to a fourth area successively. Lastly, file system information and the like is acquired from the fourth area (step S17 in FIG. 3, and step S57 in FIG. 4). All or a portion of acquired information is stored in the flash memory 5 (step S19, and step S59). At this time, if necessary, presence indication information of the fourth area is stored.

When an optical disc is inserted at a second time, identification information recorded in a first user data area is acquired. When it is specified that an optical disc is one whose final area was retrieved at the last time (step S13, step S53, Yes), and it is determined, based on presence indication information of fourth area which is a final area at the time of last retrieving, that the area exists on the optical disc (step S16, step S56, Yes), a start address of next area and the like is acquired from the fourth area to an Nth area, and file system information and the like is acquired from the Nth area (step S18, step S58).

If it is sufficient that file system information is acquired for reproduction of optical disc, it is sufficient that an Nth area in which the information is recorded is retrieved, although it depends on a reproduction method, a kind of optical disc, and the like. If information in each area is necessary, it is sufficient that, in addition to information in each area of the first to fourth areas stored in the flash memory 5, information after a fifth area is newly acquired.

Therefore, according to an optical disc reproduction apparatus of the present embodiment, as shown in FIG. 5B, it is not necessary to acquire information in each of the first to fourth areas again, and the number of access to optical disc is reduced accordingly.

As explained above, according to the present embodiment, when the system control unit 6 retrieves a final area of optical disc D, a start address of the area, and the like is stored in the flash memory 5. When the optical disc D is inserted again, and a final area is newly retrieved, it is determined whether a final area retrieved at a last time exists on the optical disc D, based on a start address of final area stored in the flash memory 5. When it is determined that a final area retrieved at a last time exists on the optical disc D, a start address of next area, and the like is acquired, starting from a final area retrieved at a last time, and a final area is retrieved. Therefore, the number of access to optical disc D is reduced, so that it is possible to reduce a period of time necessary for acquiring information necessary for reproduction of optical disc.

Further, the system control unit 6, based on a start address of final area stored in the flash memory 5, specifies a position at which presence indication information is recorded on an optical disc D whose final area was retrieved at a last time, and, based on information recorded at the specified position of optical disc D whose final area is newly retrieved, determines whether a final area retrieved at a last time exists on the optical disc D. Therefore, it is possible to securely determine whether a final area exists.

Furthermore, the system control unit 6 stores identification information recorded on an optical disc D in the flash memory 5 in such a manner that it corresponds to border information including a start address of final area, and the like. In a case where it is determined that identification information recorded on the optical disc D whose final area is newly retrieved is stored in the flash memory 5, based on border information corresponding to the identification information, and the like, it is determined whether a final area exists. Therefore, it is possible to reduce a period of time necessary for acquiring information necessary for reproduction in correspondence with a plurality of optical discs D.

Incidentally, in the above-mentioned embodiment, the present invention has been applied to an optical disc reproduction apparatus which reproduces recorded information from DVD-R and DVD-RW on which information has been recorded according to a multi-border method, and CD-R and CD-RW on which information has been recorded according to a multi-session method. However, the present invention is not limited to it. For example, the present invention may be applied to an information reproduction apparatus for reproducing recorded information from DVD+R and DVD+RW on which information has been recorded according to a multi-session method, and another optical disc (for example, BD (Blue-ray Disc), and HDDVD (registered trademark)), or information-recorded medium other than an optical disc (for example, hard disc, flash memory, MT (Magnetic Tape), and the like), and the like. Further, for example, the present invention may be applied to an information recording apparatus for writing information on such recorded medium, and the like.

Incidentally, the present invention is not limited to the above embodiment. The above embodiment is an example. What has the substantially same structure as technical idea included in the claims, and produces the substantially same operation and effect, is encompassed in a technical scope of the present invention, even if it is in any form of the invention.

All of disclosure of Japanese Patent Application No. 2005-379296 filed on Dec. 28, 2005, including the specification, the claims, the drawings, and the abstract, is incorporated by reference in its entirety.

1-6. (canceled)

7. A final area retrieving apparatus, comprising:
an acquiring device which acquires information necessary for reproduction of recorded information, from a recorded medium on which information has been recorded, by a recording method by which a plurality of information pieces can be additionally recorded on the recorded medium with one information piece recorded in each divided area, and by which next-area position information indicative of a position of next-area in which information is next-time recorded is recorded in the area, and
wherein the final area retrieving apparatus retrieves a final area in which information has been finally recorded on the recorded medium,
the final area retrieving apparatus, comprising:
a retrieving device which starts retrieval of the next area position information by the acquiring device, from an area in which information has been firstly recorded on the recorded medium, and successively specifying the position of area in which information has been next-time recorded, to retrieve a final area,
a storing device which stores at least final area position information indicative of the position of the retrieved final area, and
a final area presence determining device which, at the time of newly retrieving the final area by the retrieving device, determines whether the retrieved final area exists on the recorded medium being newly retrieved, based on the stored final area position information,
wherein in a case where it is determined by the final area determining device that the retrieved final area exists, the retrieving device starts acquiring of the next area position information by the acquiring device, from the final area, to newly retrieve the final area.

8. A final area retrieving apparatus according to claim 7,
wherein presence indication information indicative of presence of the final area is recorded in the final area, and
the final area presence determining device specifies a position at which the presence indication information has been recorded on the. recorded medium whose final area has been retrieved, based on the stored final area position information, and determining whether the final area exists, based on information recorded at the specified position on the recorded medium whose final area is newly retrieved.

9. A final area retrieving apparatus according to claim 7,
wherein identification information for identifying the recorded medium is recorded on the recorded medium,
the storing device stores the identification information of the recorded medium whose final area has been retrieved, in such a manner that it corresponds to the final area position information of the recorded medium,
the final area retrieving apparatus further comprises an identification information determining device which determines whether the identification information recorded on the recorded medium whose final area is newly retrieved is stored in the storing device, and
in a case where it is determined by the identification information determining device that the identification information is stored in the storing device, the final area presence determining device determines whether the retrieved final area exists, based on the final area position information stored in correspondence with the identification information.

10. An information reproducing apparatus, comprises:
a final area retrieving apparatus according to claim 7, and
a reproduction control device which controls reproduction of recorded information from the recorded medium, based on the acquired information.

11. A final area retrieving method carried out in a final area retrieving apparatus,
wherein the final area retrieving apparatus comprises:
an acquiring device which acquires information necessary for reproduction of recorded information, from a recorded medium on which information has been recorded, by a recording method by which a plurality of information pieces can be additionally recorded on the recorded medium with one information piece recorded in each divided area, and by which next-area position information indicative of a position of next-area in which information is next-time recorded is recorded in the area, and
a reproduction control device which controls reproduction of recorded information from the recorded medium, based on the acquired information
wherein the final area retrieving apparatus retrieves a final area in which information has been finally recorded on the recorded medium,
the final area retrieving method, comprising:
a first retrieving process of starting retrieval of the next area position information by the acquiring device, from an area in which information has been firstly recorded on the recorded medium, and successively specifying the position of area in which information has been next-time recorded, to retrieve a final area,
a storing process of storing at least final area position information indicative of the position of the retrieved final area,
a final area presence determining process of, at the time of newly retrieving the final area, determining whether the retrieved final area exists on the recorded medium being newly retrieved, based on the stored final area position information, and
a second retrieving process of, in a case where it is determined in the final area presence determining process that the retrieved final area exists, starting acquiring of the next area position information by the acquiring device, from the final area, to newly retrieve the final area.

12. A program recorded medium on which a final area retrieving program is computer-readably recorded,
the final area retrieving program, causing a computer included in a final area retrieving apparatus, comprising:
an acquiring device which acquires information necessary for reproduction of recorded information, from a recorded medium on which information has been recorded, by a recording method by which a plurality of information pieces can be additionally recorded on the recorded medium with one information piece recorded in each divided area, and by which next-area position information indicative of a position of next-area in which information is next-time recorded is recorded in the area, and
wherein the final area retrieving apparatus retrieves a final area in which information has been finally recorded on the recorded medium,
to function as:
a retrieving means device which starts retrieval of the next area position information by the acquiring device, from an area in which information has been firstly recorded on the recorded medium, and successively specifying the position of area in which information has been next-time recorded, to retrieve a final area,
a storing device which stores at least final area position information indicative of the position of the retrieved final area, and
a final area presence determining device which, at the time of newly retrieving the final area by the retrieving device, determines whether the retrieved final area exists on the recorded medium being newly retrieved, based on the stored final area position information,
wherein in a case where it is determined by the final area presence determining device that the retrieved final area exists, the retrieving device starts acquiring of the next area position information by the acquiring device, from the final area, to newly retrieve the final area.
